(19) United States
(12) Patent Application Publication
(10) Pub. No.: US 2007/0234672 A1
(43) Pub. Date: Oct. 11, 2007

(54) Reinforced building structure having durability to earthquake

(75) Inventors: Mio Namba, Chita-shi (JP); Katsutoshi Sakurai, Nagoya-shi (JP); Teruyuki Kato, Nagoya-shi (JP)

Correspondence Address: KRATZ, QUINTOS & HANSON, LLP, 1420 K Street, N.W., Suite 400, WASHINGTON, DC, 20005, US

(73) Assignee: NICHIHA CO., LTD., Nagoya-shi (JP)

(21) Appl. No.: 11/452,359

(22) Filed: Jun. 14, 2006

(30) Foreign Application Priority Data
Mar. 24, 2006 (JP) 2006-002128U

(51) Int. Cl. E06B 3/54

(52) U.S. Cl. 52/474

(57) ABSTRACT

The reinforced building structure which is lightweight, and working efficiency is preferable, and has a fire preventive performance and a decay durability, and can improve earthquake resistance strength without relying bracing. The structural building frame includes a pair of columns placed at facing in right and left, the upper horizontal member and the lower horizontal member jointed to each columns. The predetermined size of fiber reinforced cement siding 9 is installed in the structural building frame by horizontal boarding, and is fastens by nail 4 or screw by predetermined spacing.

This application claims priority under 35 U.S.C. §119 to Japanese Utility Model Application No. 2006-002128 filed on Mar. 24, 2006, the entire disclosure of which is incorporated herein by reference in its entirety.

### BACKGROUND OF THE INVENTION

1. Field of the Invention

The present invention is related to reinforced building structure. In particularly wooden building, reinforced building structure using board for structural use such as fiber reinforced cement siding is related to.

2. Description of the Related Art

The following description sets forth the inventor's knowledge of related art and problems therein and should not be construed as an admission of knowledge in the prior art.

Platform wood flame building construction (wood frame building construction) is one of the construction methods of a wooden architecture conventionally. Platform wood flame building construction is as a construction method which sill is fixed as against foundation, and to fix wall framing by sandwiching floor framing. This wall framing is comprised of stud, sole plate, top plate and board (theating). By this arrangement, wall framing enhances horizontal rigidity and horizontal strength of an entire structure with floor framing, and earthquake resistance strength of an entire structure is improved.

For example, Oriented Strand Board that thickness is 7/16 inch (about 11.1 mm), and length and breadth size is 8 feet (2,428.4 mm)×4 feet (about 1,219.2 mm) is used as theating (board for structural use). As for Oriented Strand Board, it is fastened in top plate portion, sole plate portion and stud portion every 150-300 mm by nail, and earthquake resistant construction is formed.

However, there is the case that it is not enough in wind pressure by a natural phenomenon such as a hurricane or a tornado. As for it, Oriented Strand Board is fixed in stud, sole plate and top plate in wall framing of wood frame building construction by nail, but when mural disposition balance is not appropriate by size and a quantities of openings. In addition, there is the case that strength is not enough because OSB is fixed in stud, sole plate and top plate adequately by using the appropriate numerical nail.

In addition, in area such as State of California with much earthquake, there is the case that strength is not enough as opposed to earthquake load.

Quake-resistance standards is strengthened at any time by experience of a big earthquake of the past. However, there is designation that fortified quake-resistance standards is not enough for earthquake resistance strength either.

In Japan with much earthquake and typhoons, earthquake resistance strength of wall structure is clarified by modality and size of board, dimension and spacing of fastening nail defined by Building Standard Law of Japan and notification of Japan Ministry of Land, Infrastructure and Transport.

In addition, as for the earthquake resistance strength of a specific method of construction and wall structure comprised various material, performance evaluation test takes place individually at the test station which Minister of Land, Infrastructure and Transport approves. And Minister of Land, Infrastructure and Transport examines authorization such as structure approaches in reference by the test result. When the test is approved, an application is recognized as wall structure having the earthquake resistance strength which a minister approved.

On the other hand, invention of EXTERNAL WALL CONSTRUCTION is disclosed by U.S. Pat. No. 6,526,715 B2. This patent takes place partly in Japan, and Ministerial Approval is acquired as bearing wall structure. As for the fiber reinforced cement siding used in this bearing wall structure, a size of one piece of face material is large with thickness 13 mm×short side 910 mm×long side 3,030 mm, and weight is heavy with about 30 kg. Therefore it is difficult to carry a face material alone and to fasten face material alone. Besides, work time becomes long because a size of a face material is large, and there is the defect which working efficiency is inferior to.

To Japanese Patent Laid-Open No. 2004-60293, invention of wall structure is disclosed. Here, embodiment and application of bearing wall structure making inherit face material of plural pieces are disclosed. However, a size of one piece of face material is large, and a short side is 910 mm, and long sides are more than 910 mm. Therefore, work time becomes long, and the problem that working efficiency is inferior in is not solved.

Thus it is conceivable that a size of face material is shortened in the purpose which face material to use is lightened, and improve working efficiency.

To Japanese Patent Laid-Open No. 2004-263500, invention of house reinforcing kit and method for using the same is disclosed. In addition, to Japanese Patent Laid-Open No. 2005-232713, invention of seismically strengthening structure for wooden frame housing, and method of seismically strengthening the same is disclosed. In these, the bearing wall which made a size of one piece of face material short is disclosed. However, in an interval of the upper horizontal member and the lower horizontal member, it is necessary to add horizontal short member to opposed column or stud. As a result, trouble of construction increases. Therefore, about the problem that the working efficiency is inferior in, it is not solved at all.

In addition, there is the problem that earthquake proofing strength cannot anticipate in opening and the portion which must construct in face material after construction of soffit. In addition, when there is constraint in construction method, construction process and construction position, it is difficult to place earthquake resisting structural element with the balance that is desirable for building. Even more particularly, it is easy to burn in wood material such as OSB being combustible material, and it might do decay by construction technique and environmental conditions of external wall.

In addition, it is using wood bracing for the purpose of reinforcement in conventional general quakeproof construction. However, simpler construction structure and approach are requested. Because, in general bearing wall structure with the use of wood bracing, there is difference in resistance at bracing let-in compression and let-in tension. Therefore, in the same bearing wall line, enough earthquake proofing indication is not shown unless it is placed so that bracing direction becomes a couple. In addition, there is difference in construction quality by ability of a builder.

Besides, in a case using bracings of 3 m-3.6 m long, it is not possible to avoid the inconvenience that gaps of 2 mm-3 mm occur in joint with bracings and horizontal members or columns. When this gap is an existing condition, and wall framing structure increases repetitive loading, the slip phenomenon which a load transforms easily in area of a zero occurs, and it leads to degradation of initial stiffness. Even more particularly, bearing wall with the use of wood bracing is the structure which big stress concentrates on in a bracing and the joint, and it might lead to risk of a breaking and brittle fracture of horizontal member and a break down of bracing buckling up. In addition, same as wood materials such as OSB, wood bracing might be decay for environmental conditions. Therefore, as for the wall framing structure with the use of wood bracing, it is not got enough earthquake resistant construction.

About the construction structure which does earthquake strengthening without using wood bracing, an invention of frame of steel earthquake proofing flame in post and beam construction is disclosed to Japanese Utility Model Laid-Open No. 3024994. Here, the example which earthquake resistant wall of a constant form to be directly connected to in concrete foundation is got by means of angle steel flame attaching to the wall body, and plan enhancement of earthquake resistance strength of structural building frame is disclosed. However, it is complicated shape and structure, and the problem that working efficiency is inferior in is not solved.

The description herein of advantages and disadvantages of various features, embodiments, methods, and apparatus disclosed in other publications is in no way intended to limit the present invention. For example, certain features of the preferred embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide reinforced building structure having durability to earthquake.

According to one aspect of some embodiments of the present invention, the reinforced building structure which is lightweight, and working efficiency is preferable, and has a fire preventive performance and a decay durability, and can improve earthquake resistance strength, and can solve described above lot of problems.

Reinforced building structure of the present invention comprises the following features:

it is not necessary to provide structural building frame with sub stratum materials such as horizontal short member to reinforce horizontal joint of fiber reinforced cement siding,

the structural building frame includes a pair of column placed at facing in right and left, the upper horizontal member joined to each columns and the lower horizontal member jointed to each columns,

the fiber reinforced cement siding is fixed in the structural building frame by horizontal boarding.

In addition, as for the present invention, an above object is achieved more effectively by reinforced building structure including the following features:

at least, fiber reinforced cement siding touches the front of for the upper horizontal member and the upper portion of each columns, and/or the lower horizontal member and lower portions of each columns,

fiber reinforced cement siding is fixed in the touch portion by predetermined spacing of not less than 30 mm and not more than 55 mm by nail or screw.

In addition, as for the present invention, an above object is achieved more effectively by reinforced building structure including the following features:

fiber reinforced cement siding touches the portion except the upper horizontal member, the upper portion of each columns, the lower horizontal member and lower portions of each columns,

fiber reinforced cement siding is fixed in the touch portion by predetermined spacing of not less than 30 mm and not more than 250 mm by nail or screw.

In addition, as for the present invention, an above object is achieved more effectively by reinforced building structure including the following features:

opening is installed in the portion except the upper horizontal member, the upper portion of each columns, the lower horizontal member and lower portions of each columns,

even more particularly, in the portion except the opening, fiber reinforced cement siding is fixed in the touch portion by predetermined spacing of not less than 30 mm and not more than 250 mm by nail or screw.

In addition, as for the present invention, an above object is achieved more effectively by reinforced building structure including the following features:

vertical width of fiber reinforced cement siding is not less than 170 mm and not more than 1,000 mm,

horizontal width of fiber reinforced cement siding is not more than 2,000 mm.

In addition, as for the present invention, an above object is achieved more effectively by reinforced building structure including the following features,

the upper horizontal member and/or the lower horizontal member is joined to each columns by joint metal fitting or reinforcing metal fitting,

the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

### EFFECTS OF THE INVENTION

In reinforced building structure of the present invention, fiber reinforced cement siding as board for structural use can be fixed easily alone. Working efficiency is raised, and it can make, besides, show a good effect as bearing wall.

In addition, the present invention can be applied in the case that it is difficult to do disposition balance of earthquake resisting structural element in building appropriately by constraint of construction method, construction process and construction position.

And fire preventive performance of wall framing structure gets possible to be raised because fiber reinforced cement siding is noncombustible material or quasi-noncombustible. In addition, it is enabled to get durability for prolonged period because fiber reinforced cement siding does not do decay like wood.

Even more particularly, it does not load much quake resistance as before as it is bracing, and it improves in structural strength by board for structural use. Therefore, all board of the bearing wall which there is on the same plane can scatter load.

Thus, reinforced building structure by the present invention can be superior to construction performance, earthquake resisting, adaptive flexibility, fire preventive performance, permanent (decay durability) critical protection, the effectiveness is extremely high.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is front view showing an example of reinforced building structure by embodiment 1 of the present invention.

FIG. 2 is plane view showing reinforced building structure in FIG. 1.

FIG. 3 is front view showing an example of reinforced building structure by embodiment 2 of the present invention.

FIG. 4 is front view showing application of reinforced building structure by embodiment 2 of the present invention.

FIG. 5 is front view which shows the comparison which is conventional reinforced building structure.

FIG. 6 is plane view showing comparison in FIG. 5.

FIG. 7 is front view showing conventional bearing wall.

### DETAILED DESCRIPTION OF THE PREFERRED EMBODIEMENTS

In the following paragraphs, some preferred embodiments of the invention will be described with reference to the attached drawings by way of example and not limitation. It should be understood based on this disclosure that various other modifications can be made by those in the art based on these illustrated embodiments.

### Embodiment 1

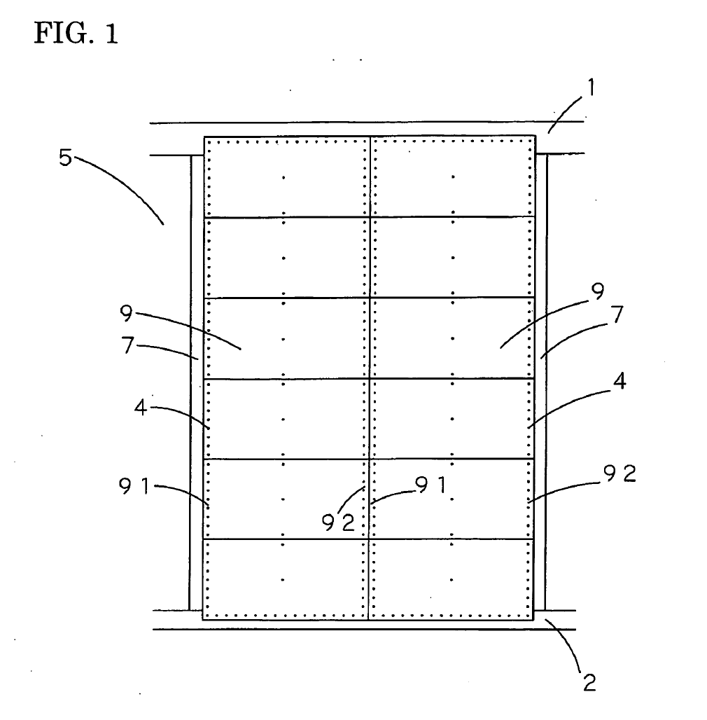

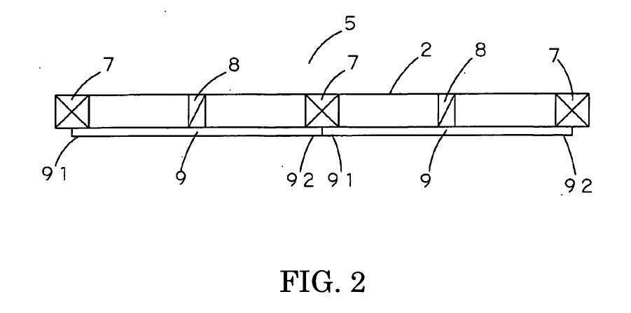

FIG. 1 and FIG. 2 show a condition of embodiment 1 of the present invention. Fiber reinforced cement siding 9 (it is abbreviated to board 9) which is face material, it is fastened by horizontal boarding for structural building frame 5 constructed as with the upper horizontal member 1, the lower horizontal member 2, column 7 and stud 8 sequentially towards the top from a bottom. Here, size of board 9 is set so that left end 91 and right end 92 of board 9 touches the front of column 7 to adapt itself to spacing of column 7.

Here, it makes board 9 of bottom line touches the lower horizontal member 2, and nail 4 is hit the long side direction along the lower side of board 9 every 50 mm, and it fastens with board 9. Even more particularly, it fastens with board 9 by hitting nail 4 to the short side direction along the left side and the light side of board 9 every 50 mm in the portion that left end 91 and right end 92 of board 9 touch with column 7.

In the portion that board 9 touches stud 8, it fastens with board 9 by hitting nail 4 to short side direction of board 9 every 200 mm.

Next, in each board 9 (the lower horizontal member 2 and the upper horizontal member 1 is not touched) which is equivalent to the second line from the fifth line when it is counted from a bottom, it fastens with board 9 by hitting nail 4 to short side direction of board 9 every 50 mm in the portion that left end 91 and right end 92 of board 9 touching column 7. In addition, in a like manner, in each boards 9 which is equivalent to the second line from the fifth line when it is counted from a bottom, it fastens with boards 9 by hitting nail 4 to short side direction of board 9 every 200 mm in portion touching stud 8.

In embodiment 1, embodiment 2 and application to be described below of the present invention, about nail 4 to use, a diameter of body is 2.75 mm, and overall length is 50 mm, and shape of body is smooth. A diameter of body and overall length of this nail 4 are larger than nail as shown in comparison described below, and body is the shape which asperity is not installed in.

When it fastens to the upper horizontal member 1, the lower horizontal member 2 and column 7 with board 9, breaking occurs in board if spacing to hit nail 4 is smaller than 30 mm, and strength falls if spacing to hit nail 4 is had a long than 55 mm. Therefore, desirable spacing to hit nail 4 is longer than 30 mm, and it is shorter than 55 mm when it fastens to the upper horizontal member 1, the lower horizontal member 2 and column 7 with board 9.

For reasons of the same, as for the spacing to hit nail 4 of a case to fasten to stud 8 with board 9, longer than 30 mm are desirable. When it fastens to stud 8 with board 9, if spacing to beat against nail 4 is longer than 250 mm, wraping and out-of-plate displacement occur in face outside direction of board and are unfavorable to produce strength. Therefore, desirable spacing to hit nail 4 when it fastens to stud 8 with board 9 is not less than 30 mm and not more than 250 mm.

In addition, in wood frame building construction, it is equivalent to sole plate of structural building frame with the lower horizontal member and is equivalent to top plate with the upper horizontal member. In addition, column and stud are equivalent to stud.

### Embodiment 2

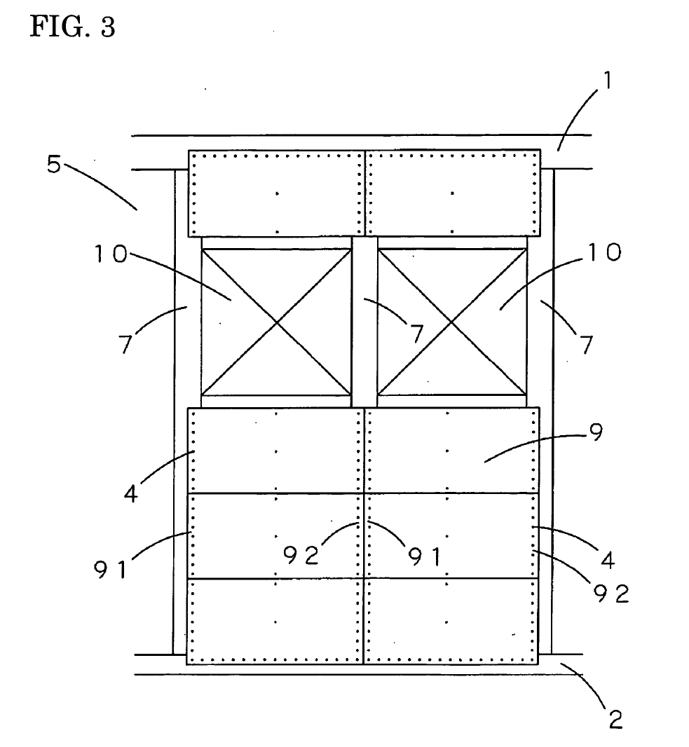

FIG. 3 shows embodiment 2 of the present invention. For this case, it cannot fasten in board of the fourth line and the fifth line which it is counted from a bottom so that there is opening 10 in structural building frame 5. It is fastened board 9 to total four lines of bottom line, the second line, the third line and the sixth line. For this case, position of nail 4 in each board 9 is the same as embodiment 1.

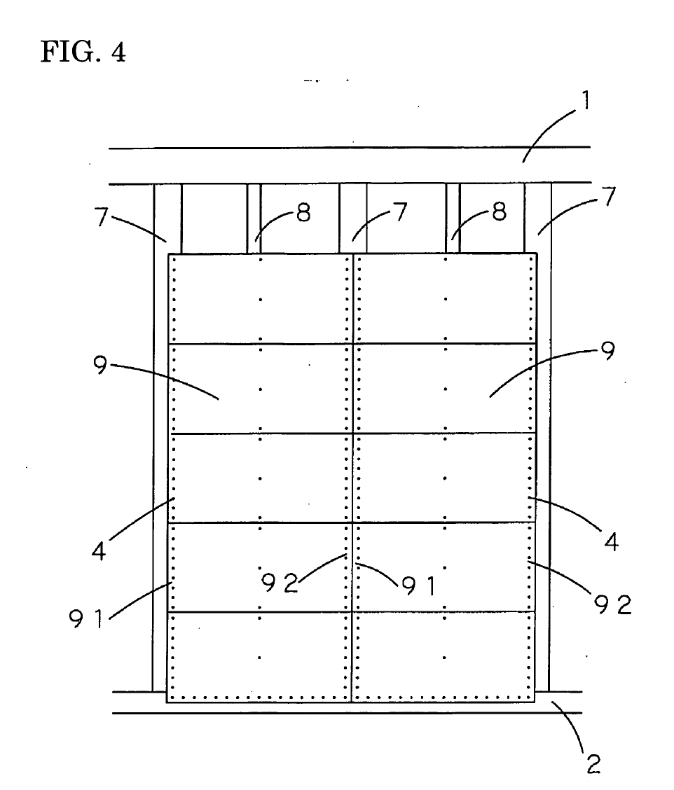

FIG. 4 shows application of embodiment 2 of the present invention. In a step of construction of soffit, it is the case which it is not fastened board 9 to the upper horizontal member in soffit. For this case, it is not fastened in the sixth line board which it is counted from a bottom to the upper cross frame material 1. The position of nail 4 in each board 9 is the same as embodiment 1.

### Embodiment 3

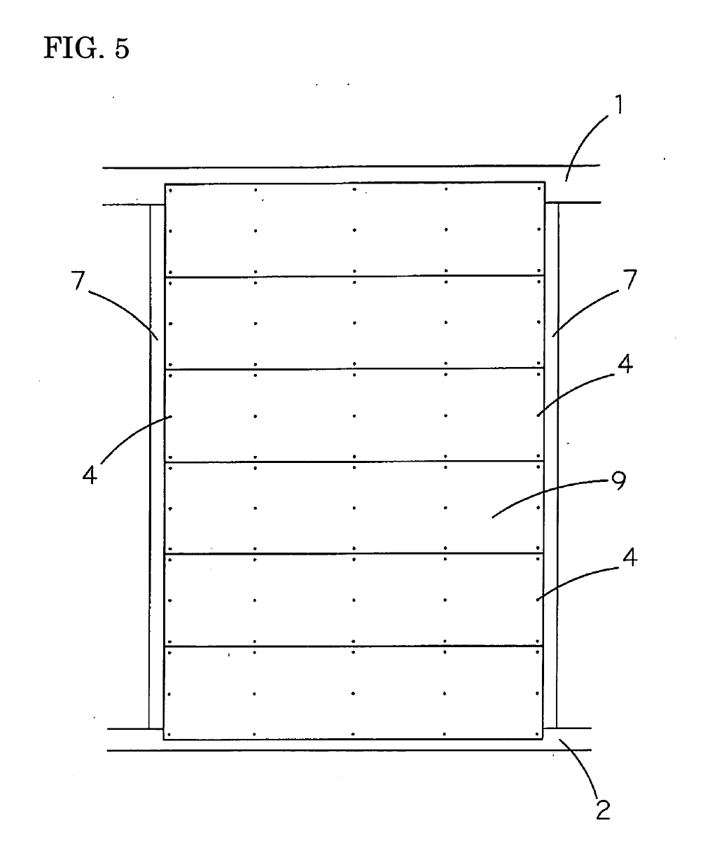

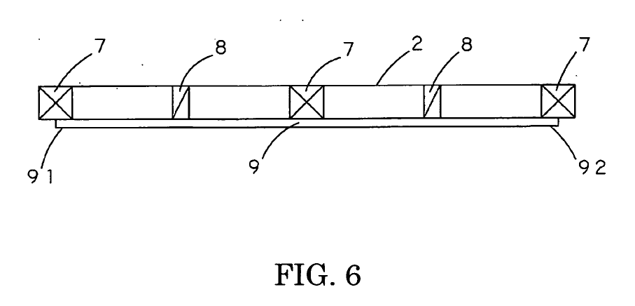

It is comparison, and FIG. 5 and FIG. 6 show an example of a fiber reinforced cement siding wall of a general method of construction (it is horizontal boarding and it fastens fiber reinforced cement siding to structural building frame direct)

In the portion that board 9 touches column 7 or stud 8, it fastens with board 9 by hitting nail 4 in short side direction of board 9 every 200 mm. As for nail 4 to use, a diameter of body is 2.3 mm, and overall length is 38 mm, and shape of body is ring.

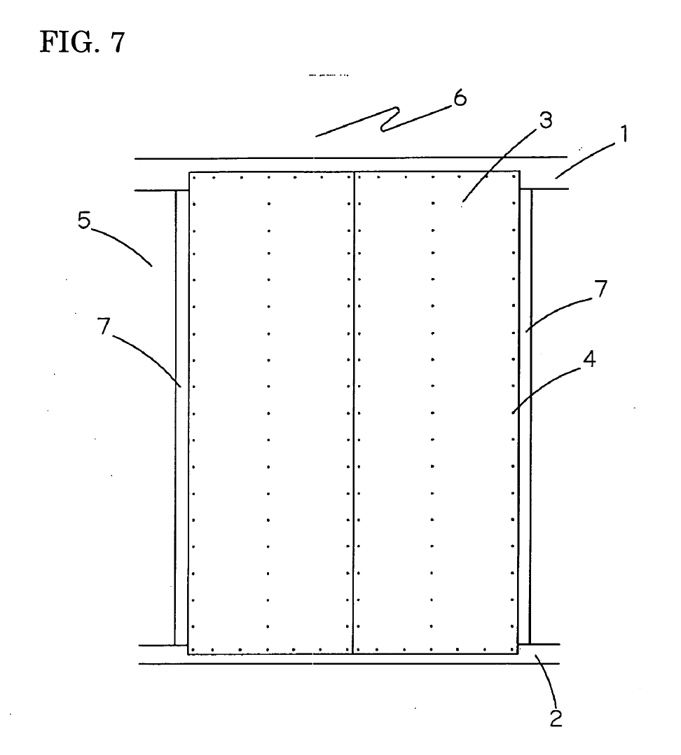

FIG. 7 is conventional embodiment, face material 3 of the dimension that can join the upper horizontal member 1 and the lower horizontal member 2 together in one piece of face material is used, and bearing wall 6 fixed to structural building frame 5 by nail 4 is shown.

Next, about wall structure (embodiment 1, embodiment 2 and comparison) of the present invention, the result which did strength test is shown for table 1-3. Comparison is wall structure by a general method of construction (it is horizontal boarding and it fastens fiber reinforced cement siding to structural building frame direct) of the fiber reinforced cement siding that it is usually constructed as a wall.

### Test Method

There is test method on the basis of test method for Ministerial Approval based on Regulation of Paragraph (8) of table 1 in Paragraph 4 of Article 46 of the Enforcement Ordiance of the Japanese Building Standard Law:

Wherein Regulation of Paragraph (8) of table 1 in Paragraph 4 of Article 46 of the Enforcement Order of the Japanese Building Standard Law is mentioned in announced “An approach book about test and evaluation of wooden bearing wall and the magnification” by designated performance evaluation organization,

Performance assessment engine is established to 56 of Article 77 of the Japanese Building Standard Law and 2 of Article 71 of the Ministerial Order Concerning Designated Qualifying Examination Body and Others based on the Japanese Building Standard Law.

This test method is almost equivalent to test method of the following industry standard.

1. Japanese Industrial Standard. (1994).

### JIS A 1414 Methods of Performance Test of Panels for Building Construction. (6.14)

2. ASTM E564-76. (1995). Standard Method of Static Load Test for Shear Resistance of Framed Walls for Buildings, American Society for Testing and Materials.

3. ASTM E72-80. (2002). Standard Methods of Conducting Strength Tests of Panels for Building Construction, American Society for Testing and Materials.

### Table 1

Table 1 shows description of a sample under test.

### Table 2

Table 2 shows “load-distortion angle and displacement data” of embodiment 1, embodiment 2 and comparison.

### Table 3

Table 3 shows “a load-displacement diagramatic chart” of embodiment 1, embodiment 2 and comparison.

In test data, the greatest strength (maximum load) of embodiment 1 is about 2.4 times of comparison, the greatest strength (maximum load) of embodiment 2 is about 1.5 times of comparison. It is so that shear strength of the whole structural building frame by shape change of joint of board and nail grows big by making spacing between nails short and making body of nail big.

Max strength of embodiment 2 is smaller than embodiment 1, because total quantities of board and total quantities of nail in embodiment 2 are less than embodiment 1.

Therefore, even if area of one piece of strength face material in embodiment 1 and embodiment 2 are made small, bearing wall structure having superior earthquake resistant performance can be realized.

In addition, application of the present invention is shown in FIG. 4. In this case, for a step of construction of soffit, it is not fastened board to the upper horizontal member in soffit. Therefore, board in top line cannot install. However, enough bearing wall structure is possible with a fiber reinforced cement siding wall by horizontal boarding. Same as embodiment 2 shown in FIG. 3, in this application, because total quantities of board and total quantities of nail are less than embodiment 1, wall magnification (earthquake resistance strength) tends to smaller than embodiment 1.

Thus, wall magnification of embodiment 2 and application is reduced in comparison with embodiment 1, but, in the case of quakeproof recovery, it is very useful in the portion where is hard to secure bearing wall.

For example, Designated Evaluation Body evaluates Housing Performance Evaluation of earthquake resistant grade and wind-resistant grade based on Japan Housing Performance Indication Standards, Embodiment 2 and an application handle as associate bearing wall, and strength is counted, and it can be evaluated, Wherein Designated Evaluation Body is determined by regulation of Article 7-10 of The Housing Quality Assurance Act, wherein Japan Housing Performance Indication Standards is based on Paragraph 1 of Article 3 of the Housing Quality Assurance Act and sub-paragraph 1346 of notification issue which Ministry of Land, Infrastructure and Transport notified on Aug. 14, 2001, Wherin Housing Performance Evaluation is based on Paragraph 1 of Article 5 of the Housing Quality Assurance Act, Article 1 of the Housing Quality Assurance Act Enforcement Regulation and sub-paragraph 1347 of notification issue which Ministry of Land, Infrastructure and Transport notified on Aug. 14, 2001.

In addition, it is not illustrated, there is form comprising structural building frame using joint metal fitting or reinforcing metal fitting. In this case embodiment 1, embodiment 2 and application can be applied.

In a like manner, in structural building frame having a performance capability of bearing wall structure which joint metal fitting or reinforcing metal fitting has a function of reinforced structure for earthquake, embodiment 1 or embodiment 2 or application is applied, and combination bearing wall can be comprised.

In addition, the structural building frame in reinforced building structure of the present invention explained framework building construction mainly, however, the same application is possible about construction method such as wood frame building construction or log frame construction method.

In addition, in structural building frame in reinforced building structure of the present invention, there are construction method and structure based on basic dimension to describe below:

inch module doing spacing of column and stud in 16 inch (about 406.4 mm), 20 inch (about 508.0 mm), 24 inch (about 609.6 mm),

the meter module which assumes spacing of column and stud 500 mm,

the shaku module which assumes spacing of column and stud 1.5 shakus (about 455 mm).

When it installs in fiber reinforced cement siding to these building frame by horizontal boarding, in inch module, it is possible that vertical width of board is more than 170 mm (about 6.69 inch) and less than 1,000 mm (about 3.281 ft or about 39.37 inch), horizontal width of board is less than 1,828.8 mm (6 ft or 72 inch).

For example, in inch module, when it fastens in boards of horizontal width of 1,219.2 mm (4 ft or 48 inch) in vertical width of 610 mm (about 24 inch) on the structural building frame which is height of 2,438.4 mm (8 ft or 96 inch) in width of 1,219.2 mm (4 ft or 48 inch), the boards of vertical width 610 mm are used for three lines, and the boards which cut vertical width to 608.4 mm are used for top line touching the upper cross frame material.

In addition, for example, when it fastens in board of vertical width of 1,219.2 mm (4 ft or about 48 inch) in horizontal width of 500 mm (about 19.69 inch) on the same structural building frame, the boards of vertical width 500 mm are used for four lines, and the boards which cut vertical width to 438.4 mm is used to top line touching the upper cross frame material.

In a like manner, in meter module, for example, when it fastens in board of horizontal width of 2,000 mm in vertical width of 900 mm on the configuration building frame which is height of 3,000 mm in width of 2,000 mm, the boards of vertical width 900 mm are used for three lines, and the boards which cut to 300 mm is used for top line touching the upper cross frame material.

In addition, as for the thickness of board, the 12 mm (about ½ inch) above is desirable. However, thickness is under 12 mm, and required earthquake resistance strength is accepted, and thickness can be set.

Even more particularly, fiber reinforced cement siding does not have setting of presence of surface coating, as for the face fastening in board, even the external wall side or intine side is possible.

When durability of bearing wall structure wants to be secured more, it is desirable to put finishing coating for the front of board in external wall in the case of using no coating board.

A chamfering work may be put for edge side of board, in addition, shape of joint between board is preferable in which of butt joint, shiplap joint, tongue-and-groove joint or those assembly.

As an example, in the case which board is used in interior finish work, joint is made by making thrust each other's side of chamfering machined board, there is the constitution which it coats, and fill material such as mud or putty is embedded in this joint and are not outstanding.

Moreover, in a bottom, left and right edge of board, it is desirable to secure with spacing of end distance and edge distance of higher than 15 mm so that breaking of board occurs when end distance and/or edge distance of nail or screw to hit board are under 15 mm. The nail that it is desirable to use is a stainless steel nail prescribed in JISA5508, and a body diameter is higher than 2.75 mm, and overall length is higher than 50 mm, and shape of body is smooth. In addition, in the same as thickness of board, nail can set a body diameter, overall length and shape of body which adapted itself to required earthquake resistance strength, furthermore, it is possible to use an iron round nail or nail for gypsum board of industry standard.

When screw is used, and it fastens in board, the screw which is desirable for use is cross recessed countersunk head tapping screw prescribed by JISB1122, and diameter is higher than 3 mm, and overall length is higher than 30 mm. This depends upon required earthquake resistance strength same as described above, sizing such as diameter or overall length can be set. Screw for gypsum board working or Screw for light ceiling working can be set.

In addition, in construction of screw, prepared hole can be opened in board before, and it is desirable to screw this prepared hole. It is desirable for diameter of prepared hole to be slightly smaller than screw diameter or to be same as screw diameter. Even more particularly, it is desirable to use electric power tools such as electric screwdriver.

By them, an edge of board can be prevented from being broken.

While the present invention may be embodied in many different forms, a quantities of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.q., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e. it should be understood that the present invention has a quantities of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion therof, etc. In some examples, various embodiments may include overlapping features. In this disclosure and during the prosecution of this case, the following abbreviated terminology may be employed: “e.q.” which means “for example;” and “NB” which means “note well”.

TABLE 1

| | Embodiment 1 | Embodiment 2 | Comparison |
|---|---|---|---|
| Size of framework materials | Width: 1,820 mm × Height: 2,730 mm | | |
| Quality of material of | The upper horizontal member: Douglas fir | | |
| framework | The lower horizontal member, Column, Stud: Japanese cedar | | |
| Member subject size of | The upper horizontal member: 180 mm × 105 mm | | |
| framework | The lower horizontal member: 105 mm × 105 mm | | |
| | Column: 105 mm × 105 mm | | |
| | Stud: 105 mm × 45 mm | | |
| Board for structural use | Fiber reinforced cement siding Thickness: 12 mm | | |
| | Short side: 455 mm × Long side: 910 mm | | Short side: 455 mm × Long |
| | | | side: 1,820 mm |
| Spacing to fasten in nail | The left end and the right end of | The left end and the right end of | It is spacing of 200 mm to column |
| | boards from the 1st to the 6th line: | boards from the 1st to the 6th line: | |
| | it is spacing of 50 mm to column | it is spacing of 50 mm to column | |
| | The center portion of boards from | The center portion of boards from | |
| | the 1st to the 6th line: | the 1st to the 4th line: | |
| | it is spacing of 200 mm to stud | it is spacing of 200 mm to stud | |
| | The 1st line board: | The 1st line board: | |
| | it is spacing of 50 mm to the | it is spacing of 50 mm to the | |
| | lower horizontal member | lower horizontal member | |
| | The 6th line board | The 4th line board | |
| | it is spacing of 50 mm to the | it is spacing of 50 mm to the | |
| | upper horizontal member | upper horizontal member | |

| | | |
|---|---|---|
| Nail | Body diameter: 2.75 mm × Overall length: 50 mm | Body diameter 2.3 mm × Overall |
| | (Body shape: smooth) | length: 38 mm |
| | | (Body shape: smooth) |

TABLE 2

| Distortion | Dis- | Load (kN) | | |
|---|---|---|---|---|
| angle | placement | | | Conventional |
| (rad) | (mm) | Embodiment 1 | Embodiment 2 | embodiment |
| 1/450 | 5 | 4.90 | 3.18 | 1.76 |
| 1/300 | 7 | 5.55 | 3.67 | 2.11 |
| 1/200 | 11 | 6.60 | 4.27 | 2.35 |
| 1/150 | 14 | 7.20 | 4.76 | 2.94 |
| 1/100 | 22 | 8.15 | 5.33 | 3.33 |
| 1/75 | 29 | 8.70 | 5.75 | 3.63 |
| 1/50 | 43 | 9.85 | 6.44 | 4.31 |
| MAX LOAD | — | 15.21 | 10.08 | 6.82 |

TABLE 3
Load-Displacement Diagramatic Chart

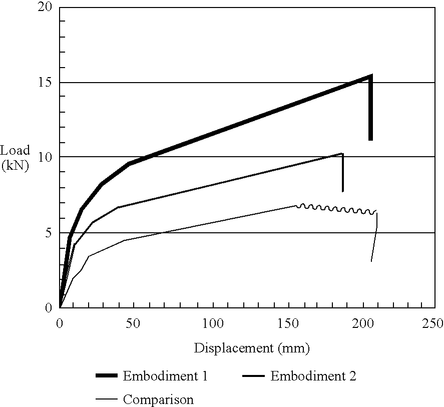

What is claimed is:

1. Reinforced building structure comprising the following features:
it is not necessary to provide structural building frame with sub stratum materials such as horizontal short member to reinforce horizontal joint of fiber reinforced cement siding,
the structural building frame includes a pair of column placed at facing in right and left, the upper horizontal member joined to each columns and the lower horizontal member jointed to each columns,
the fiber reinforced cement siding is fixed in the structural building frame by horizontal boarding.

2. The Reinforced building structure as recited in claim 1,
wherein fiber reinforced cement siding touches the front of the upper horizontal member and the upper portion of each columns, and/or the lower horizontal member and lower portions of each columns,
wherein fiber reinforced cement siding is fixed in the touch portion by predetermined spacing of not less than 30 mm and not more than 55 mm by nail or screw.

3. The Reinforced building structure as recited in claim 2,
wherein fiber reinforced cement siding touches the portion except the upper horizontal member, the upper portion of each columns, the lower horizontal member and lower portions of each columns,
wherein fiber reinforced cement siding is fixed in the touch portion by predetermined spacing of not less than 30 mm and not more than 250 mm by nail or screw.

4. The Reinforced building structure as recited in claim 3,
wherein opening is installed in the portion except the upper horizontal member, the upper portion of each columns, the lower horizontal member and lower portions of each columns,
wherein in the portion except the opening, fiber reinforced cement siding is fixed in the touch portion by predetermined spacing of not less than 30 mm and not more than 250 mm by nail or screw.

5. The Reinforced building structure as recited in claim
wherein vertical width of fiber reinforced cement siding is not less than 170 mm and not more than 1,000 mm,
wherein horizontal width of fiber reinforced cement siding is not more than 2,000 mm.

6. The Reinforced building structure as recited in claim 2,
wherein vertical width of fiber reinforced cement siding is not less than 170 mm and not more than 1,000 mm,
wherein horizontal width of fiber reinforced cement siding is not more than 2,000 mm.

7. The Reinforced building structure as recited in claim 3,
wherein vertical width of fiber reinforced cement siding is not less than 170 mm and not more than 1,000 mm,
wherein horizontal width of fiber reinforced cement siding is not more than 2,000 mm.

8. The Reinforced building structure as recited in claim 4,
wherein vertical width of fiber reinforced cement siding is not less than 170 mm and not more than ,000 mm,
wherein horizontal width of fiber reinforced cement siding is not more than 2,000 mm.

9. The Reinforced building structure as recited in claim 1,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

10. The Reinforced building structure as recited in claim 2,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

11. The Reinforced building structure as recited in claim 3,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

12. The Reinforced building structure as recited in claim 4,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

13. The Reinforced building structure as recited in claim 5,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

14. The Reinforced building structure as recited in claim 6,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

15. The Reinforced building structure as recited in claim 7
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.

16. The Reinforced building structure as recited in claim 8,
wherein the upper horizontal member and/or the lower horizontal member is joined to each columns by joint metal fitting or reinforcing metal fitting,
wherein the joint metal fitting or reinforcing metal fitting is joined by the position which is not interfered in touched fiber reinforced cement siding, or, the upper horizontal member and/or the lower horizontal member and/or each columns has partly broken away portion corresponding to shape and thickness of joint metal fitting or reinforcing metal fitting, and joint metal fitting or reinforcing metal fitting is embedded in partly broken away portion, and it is connected, the joint metal fitting or reinforcing metal fitting does not interfere in fiber reinforced cement siding.
